(19) United States
(12) Patent Application Publication
(10) Pub. No.: US 2020/0074475 A1
(43) Pub. Date: Mar. 5, 2020

(54) INTELLIGENT SYSTEM ENABLING AUTOMATED SCENARIO-BASED RESPONSES IN CUSTOMER SERVICE

(71) Applicant: Dariusz Zabrzenski, Kamieniec Zabkowick (PL)

(72) Inventor: Dariusz Zabrzenski, Kamieniec Zabkowick (PL)

(21) Appl. No.: 16/117,084

(22) Filed: Aug. 30, 2018

(51) Int. Cl. G06Q 30/00; H04L 12/58; G06F 17/27; G06F 17/28

(52) U.S. Cl. CPC G06Q 30/016; G06F 17/2881; G06F 17/2785; H04L 51/02

(57) ABSTRACT

This embodiment describes a system and method for automated response system with the ability for API integration with channel providers (chat solutions). The embodiment allows creating chatbots to automate customers service processes. Each scenario which is implied through the embodiment is based on an intelligent system which detects and process natural human language by NLP technology. To classify proper response, the embodiment employs optimized TF-IDF and Naive Bayes algorithms, along with Sorensen-Dice coefficient and Modified Common Subsequence optimization. It allows real-time responses imitating human language which complexity depends on a scenario created by the user through the embodiment interface.

### BACKGROUND

This application is related to some prior art that presently appears relevant as part of the embodiment employs method disclosed by U.S. Pat. No. 6,401,061 issued at 4 Jun. 2002.

Currently, responsive customer service is one of the most challenging and demanding fields in any customer-oriented business. To customize conversation with real end users and at the same time, limit costs, invented embodiment shall enable a scenario-based system which allows automating customer service.

Conventional, agent-served systems often fail once it comes to timely response and instant message detection. This costly solution implies also a difficulty once customer needs to be served in a national language. The embodiment, address some of those important needs by scenario-based actions build in automated response system based upon technology described in U.S. Pat. No. 6,401,061 issued at 4 Jun. 2002. It uses intelligent processing and retrieval of textual information in language processing to achieve responsive system enabling natural language phrases qualification.

### SUMMARY

The embodiment constitutes a scenario-based intelligent response system. It can be implemented in different chat solutions related in agent-customer conversations. Said embodiment enables not only intelligent method but also accessible interface which allows a user to prepare its own bot scenario of conversation. This embodiment uses integration with any chat-based solution designed to facilitate conversations, data exchange and transfer provided that such software enables API (Application Programming Interface) access.

The current growth of customer-based sale and need for easy and accessible contact places enormous pressure on almost all types of business. The embodiment can help to achieve effective onboarding, sale assistance or any other customer service which in “human-like” manner replies to customers' requests. In fact, usage of the embodiment integration is the matter of scenario implemented by the user. It enables to automate concrete spheres of contact with a customer as well as provide natural communication, based on trigger' qualifiers which begins the process or content sent and displayed through chat integrated with the embodiment.

Said integration enables to customize conversation with customers per industry, type of product or any other based on natural language qualifiers which are introduced by the user who implements this technology to their chat solutions. High flexibility of the embodiment enables integrations and implementations with different types of conversation tools enabling API access.

The functionality of integration between the embodiment and any chat solution is enabled through application API. Furthermore, a bot created through said embodiment can be trained to recognize and accept replies as qualifying under entity based on confidence score.

### DESCRIPTION OF DRAWINGS

FIG. 1—shows example usage of the embodiment and presents interface enabled from the user panel.

FIG. 2—shows example scenario-making process and presents interface enabled from the user panel.

FIG. 3—shows example of conversation performed by the bot created with the embodiment.

FIG. 4—shows example of response conveyed to the embodiment in the JSON form.

FIG. 5—shows data flow in the embodiment including placing of NLP and API communication.

FIG. 6—shows message processing flow including NLP, matching system and machine learning.

FIG. 7—shows complex matching process including Algorithms optimization, Sørensen-Dice Coefficient and NLP together with machine learning leading to either fallback action or further bot action.

### DETAILED DESCRIPTION

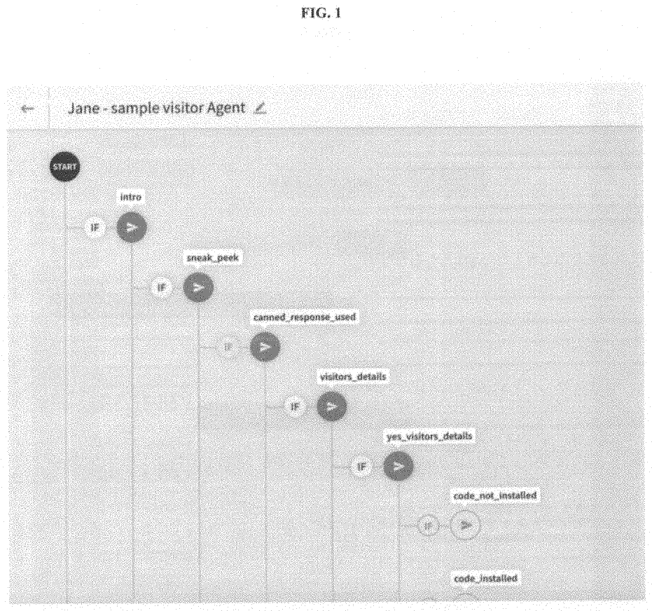

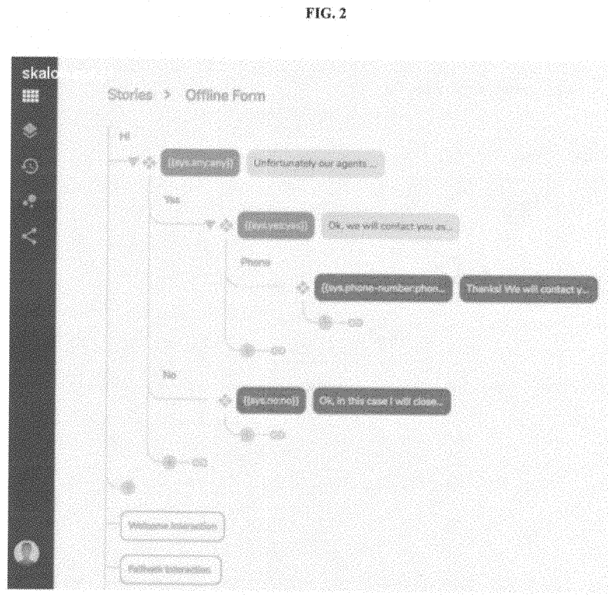

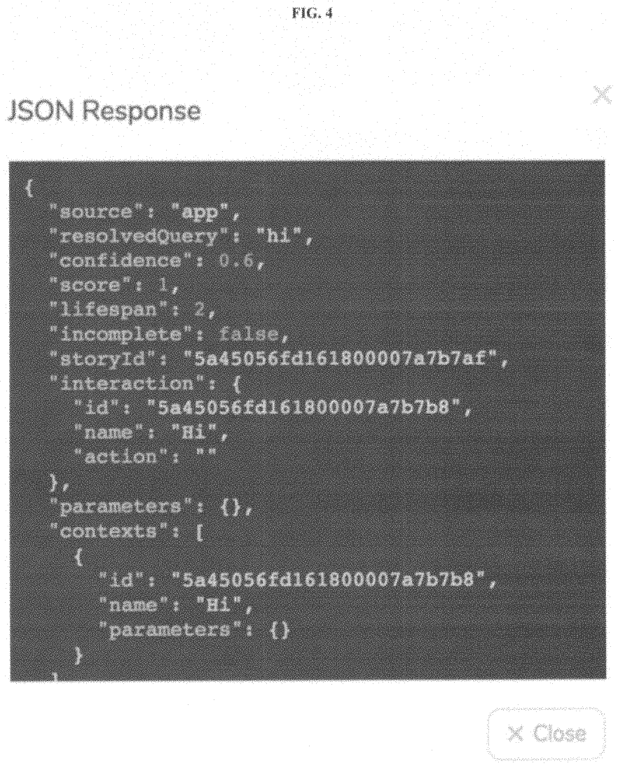

The embodiment is designed to meet the need of any customer-oriented company which is willing to automate communication with customers as far as chat conversations are concerned. The solution allows providing a real-time contextual communication between a customer and bot with a programmed scenario. It is designed to provide intelligent bots which may be customized in a unique way which allows any user to create its own scenarios upon which bot acts. Libraries of interactions are built as, so-called, stories which enable the organization and re-building structure for conversations programmed between a company and an end user (see FIG. 2). Each story is composed out of several elements to enable full bot functionality, namely (1) name, (2) description, (3) story ID, (4) metrics. First two elements are used to differentiate between stories in the interface with the latter one being optional. Story ID enables API communication with the endpoint to create a channel of effective data exchange between the embodiment and chat, Metrics enables summary of conversation conducted through solution for statistical purposes. Stories are build in a complex manner which enables to create broad relation and interaction structure of dependencies and fallbacks. For the purpose of user accessibility, the solution provides a graphics interface (see FIG. 1) and at the same time provide JSON view to enable structural view on each sequence of scenario planned by the user. Furthermore, it shows which part of the scenario is currently used and what parameters were extracted. Example depiction of JSON view response is presented by FIG. 4.

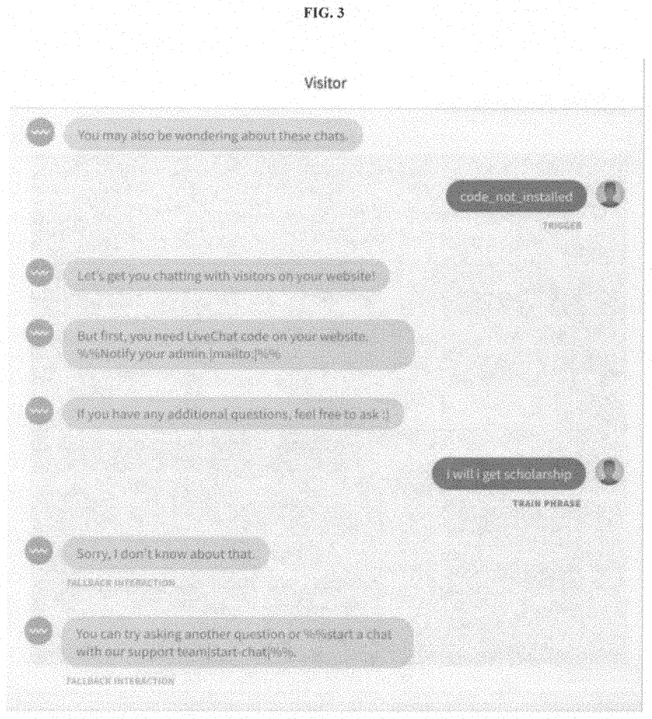

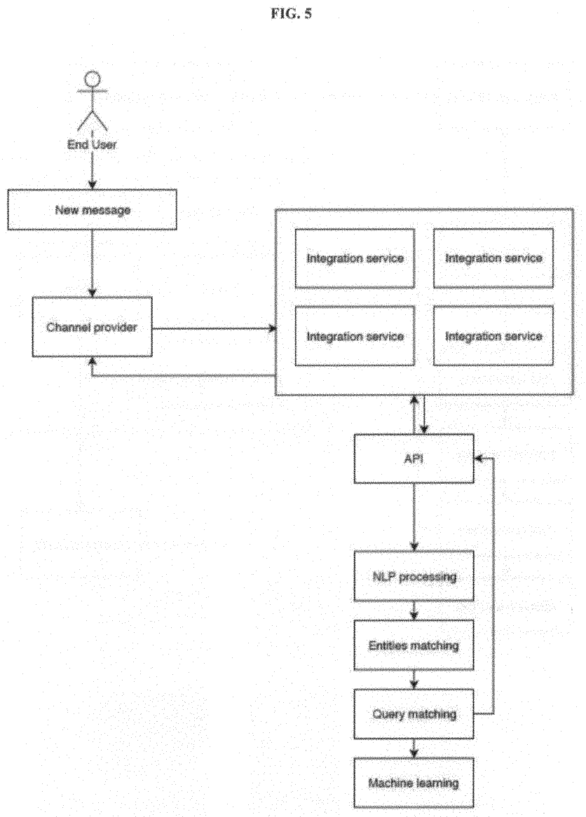

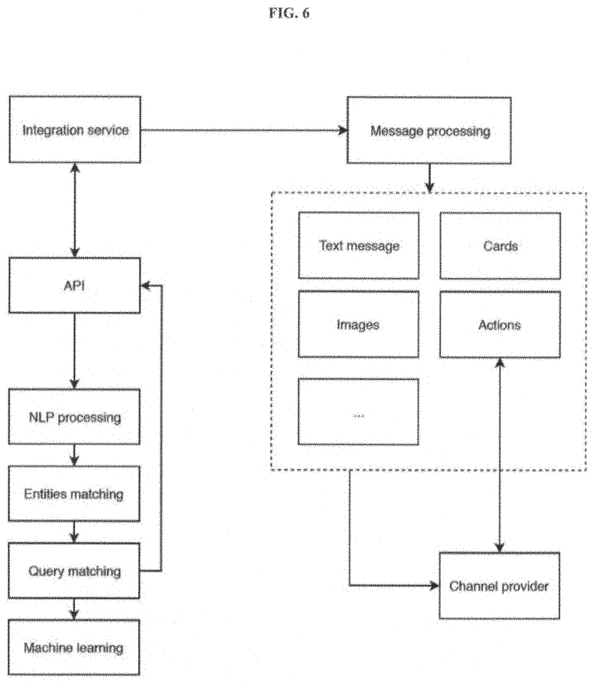

Usage of the embodiment starts with defining stories and interactions. Natural Language Processing is supported by innovative usage of modified TF-IDF (term frequency-inverse document frequency) which enables to modify weight function in a dynamic manner what results in more efficient text classification. The main functionality is based on search, matching and response generating ability which is supported by entities—subclasses of responses and qualifiers based on Natural Language Processing (NLP) (FIG. 5). Each entity can be pre-designed by a user and defined according to current needs. Entity constitutes a collection of variable data which, based on confidence score, can either link to a particular clement of a scenario or return “null” and re-ask the question to request addition inclusion of data in the system. FIG. I presents how elements of Story may be interrelated with each other and FIG. 3 depict an example scenario leading from Trigger “code_not_installed” to the fallback interaction. There is no practical limitation in a semantic classification of scenarios and extent of library created by a user is limited only by a creative approach of the user. Functional element of stories build upon matching system (example scenario—see FIG. 2 and FIG. 1). It starts with creation of scenation and integration of the embodiment with any channel provider through API or own integration. Then, end user shall enter any statement into the chat window (described as channel provider). Such information is transferred through API to the channel provider and then via integration sent to the embodiment where it is processed (FIG. 5 and FIG.6). Such processing contains Natural Language Processing. Entities Matching, Query Matching and potentially Machine Learning if applicable. At the stage of the Query Matching, the embodiment may call back its API to send a webhook back to the channel provider with an adequate response, trigger or fallback action. The described process is depicted in a FIG. 5 and FIG. 6. In practice, this process may assist during, for instance, customer onboarding process as visible on the partial scenario at FIG. 3. By creating a scenario based on certain entities with a confidence score, an end user is able to effectively communicate with the company and receive help up to his particular needs. Bots can conduct multilayer conversations with complex plots and questions. Also, during the course of its existence, language classification may improve and bring even more efficient results due to the machine learning process.

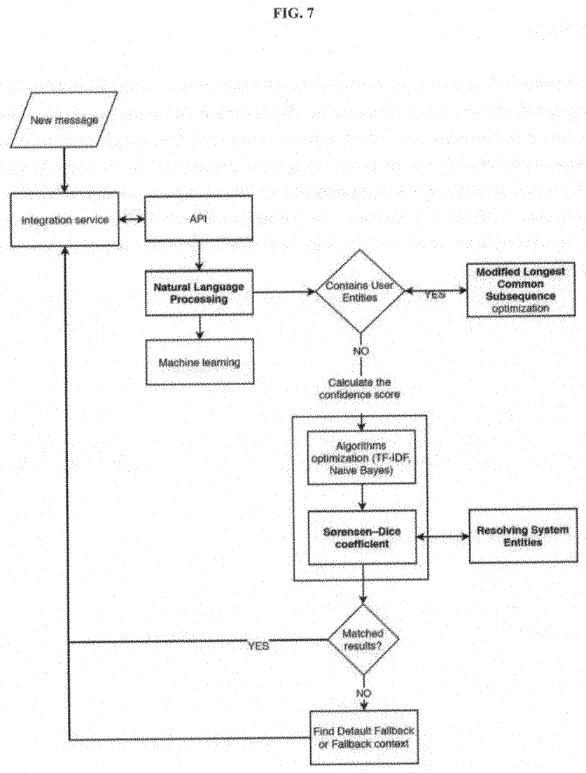

Matching systems ure responsible for pairing user input with User Says field. This system is based upon weighting chosen scoring and leading either to next element of a scenario or fallback (FIG. 2). If the score is equal to or higher than the setup Confidence Score, the bot response is triggered, consequently choosing the right matching systems can be crucial for the seamless conversation flow and interactions. If the score is less that chosen confidence score then such response cannot be properly classified according to the scheme presented at FIG. 7 and leads to the fallback action (an example of the story ending with fallback action is depicted at FIG. 3). There are different types of interactions defined by user's needs as for example invite interactions responsible for greetings at the beginning of a conversation. Next example, is a fallback interaction, which takes place when a bot is unable to classify a particular response or request and match it with an adequate part of the story. Such fallback interaction may be global—default for the whole scenario or contextual—then it depends on conversation stage and end user reactions. Furthermore, it may be created and adjusted at each stage of scenario making. Then, story-maker can decide upon next step as for example showing a general message when the bot cannot: match the user query with any of the interaction. The interaction prompts the user suggesting rewording the phrase, showing possible options or performing specific actions. Such fallback actions as well as responses may be customized by a user. To customize it, there is a possibility to base bot interactions on a confidence score. This is a unique, in-house idea, which amounts to address a need to interact with natural language. It may accept particular mistakes as belonging to the natural human language, nevertheless, scenario-maker is able to limit such level of confidence. Confidence score defines how precisely a bot will interpret what the end user says and constitutes a threshold that determines what the lowest matching score acceptable to trigger an interaction is. For example, confidence score may be set up in the range of 0-1, where 0 means 0%, 0.5=50% and 1=100%. It is possible to test different scorings in case of different stories if needed. Adequacy of technical fluency is provided by modified longest common subsequence. Mentioned solution constitutes innovative application of Levenshtein distance invented for the embodiment utility. Comparison of supplies at entities used in BotEngine is enabled due to application of sorensen-dice coefficient. Application of both methods is visible at FIG. 7.

There are two categories of entities from the technical perspective, namely (1) user made entities and (2) system entities which are pre-included in the system to raise fluency of user experience and practical possibility to govern hots. Such system entities constitute a groups collecting detection of numbers (including only integers only classification), email addresses, phone numbers, detection of synonyms to words “yes” or “no”. entities able to detect url addresses, temperature and so-called system entity “any”. Apart from the very last one, the embodiment possesses its own built-in detection of variables which may occur as a foreseeable value in the course of a regular conversation. Such functionality should enable any user to create its own bot with no necessity to start with complex programming and data collection concerning catalogues of numbers and typically shared contact details. Element listed beforehand as an entity “any” is an intelligent system which enables bot to take scheduled action once particular phrase cannot be matched by NLP with any other entity present at the embodiment. In such situation, there is a possibility to reassign variable from end user response to the statement sent by a bot to create contextual response where wording included by the end user is applied. For example, entity “any” may be used to detect US Postal Code which occurs in different configurations and contains variable signs. In case of each Entity, both user-made, scenario flow may be assigned due to the exact meaning of the wording as well as synonyms. The Embodiment is prepared to support multiple languages and due to accelerated computational complexity, it is possible to execute multiplayer scenarios in a real-time responses manner.

Entities understood as libraries may be updated on a regular, dynamic base balanced with a confidence score.

The embodiment is a solution which may be implied in any application which enables API. The flow of information presented by FIG. 6 shows in a simplified form how the embodiment uses communication between chat API and when Natural Language Processing match new message which is directed to the embodiment by integration with channel provider.

The embodiment allows intelligent machine learning process by application of Naive Bayes classifier which enables to apply probabilistic methods during request and response classification (see FIG. 7). By adding new classifiers and extending confidence scoring, a bot created through the embodiment becomes more intelligent and can assess customer reactions with visibly higher adequacy. Due to API based integration ability, it may cooperate with any tool or solution which provides REST API.

What is claimed is:

1. A computer-implemented method comprising (FIG. 3):
a. A software which automates intelligent contextual communication between the end user and bot automating customer service,
b. Wherein each of the conversations is based on. but not limited to, Natural Language Processing system by grouping categories of requests into a cluster and by grouping categories of bot responses into the clusters by matching qualifiers pre-designed by the solution itself or by the user,
c. Assuming confidence score according to the programmed scheme,
d. Wherein machine learning methods support classification into categories,
e. Designed to be implemented in chat products through API,
f. Providing the user with the ability to customize conversation scenarios in the interface.

2. Tho embodiment claimed at point 1 comprise utterances.

3. The embodiment claimed at point 1 further including a modified longest common subsequence implementation device for efficient computational complexity (FIG. 5).

4. The embodiment claimed uses confidence score to match results of entry by channel provider to the entity designed by the user, such matching takes place due to the implementation of algorithms optimization (TF-IDF), Naive Bayes classifier and Sorensen-Dice Coefficient (FIG. 7).

5. The method claimed at point 4 enables processing of different categories of data including, but not limited to, images, text, actions, cards and others through the embodiment system.
